(19) United States
(12) Patent Application Publication
(10) Pub. No.: US 2025/0287355 A1
(43) Pub. Date: Sep. 11, 2025

(54) INTER-UE COORDINATION SCHEME

(71) Applicant: Apple Inc., Cupertino, CA (US)

(72) Inventors: Chunxuan Ye, San Diego, CA (US); Chunhai Yao, Beijing (CN); Dawei Zhang, Saratoga, CA (US); Haitong Sun, Cupertino, CA (US); Hong He, San Jose, CA (US); Huaning Niu, San Jose, CA (US); Sigen Ye, Whitehouse Station, NJ (US); Wei Zeng, Saratoga, CA (US); Weidong Yang, San Diego, CA (US); Zhibin Wu, Los Altos, CA (US)

(21) Appl. No.: 18/859,002

(22) PCT Filed: Apr. 23, 2022
(86) PCT No.: PCT/CN2022/088641

§ 371 Date: Oct. 22, 2024

(51) Int. Cl. H04W 72/02; H04W 72/0453; H04W 72/25

(52) U.S. Cl. CPC H04W 72/02; H04W 72/0453; H04W 72/25

(57) ABSTRACT

Disclosed are methods, systems, and computer-readable medium for effective inter-UE coordination (IUC) scheme. One method, performed by UE-A, includes the UE-A receiving explicit request for IUC from a UE-B, the explicit request indicating a starting slot of a first resource selection window (RSW1) for IUC information, generating IUC information with a plurality of resources sets, wherein the first resource of the plurality of resources is at slot S, determining whether there is a sidelink grant within a second resource selection window (RSW2) having a starting slot (X1) determined based on (i) the starting slot of RSW1 and (ii) UE-A processing time (T″ 1) and an end slot (X2) determined based on S, based on a determination that there is not an available sidelink grant, triggering resource selection within RSW2 defined by X1 and X2, and using resources within RSW2 defined by X1 and X2 to identify resources for IUC information transmission.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have expanded network coverage by using user equipment (UEs) as relays. In particular, the relay UEs establish direct connections with other UEs in order to extent the network coverage to those UEs. The connection that a relay UE establishes with other UEs is referred to as a sidelink communication. Among other examples, the sidelink connection can be either a UE-to-network relay, where the relay UE connects a remote UE to the network, or a UE-to-UE relay, where the relay UE connects a first remote UE to a second remote UE.

### SUMMARY

The present disclosure describes methods, systems, apparatus, and computer programs for effective inter-UE coordination (IUC) scheme.

According to one innovative aspect of the present disclosure, a method to be performed by user equipment (UE) for inter-UE coordination (IUC) is disclosed. In one aspect, the method can include receiving, by the UE, an explicit request for IUC from a second UE, the explicit request indicating a starting slot of a first resource selection window (RSW₁) for IUC information, generating, by the UE, IUC information with a plurality of resources sets, wherein the first resource of the plurality of resources is at slot S, determining, by the UE, whether there is a sidelink grant within a second resource selection window (RSW₂) having a starting slot (X₁) determined based on (i) the starting slot of the (RSW₁) and (ii) a first UE processing time (T″₁) and an end slot (X₂) determined based on S, based on a determination that there is not an available sidelink grant, triggering, by the UE, resource selection within RSW₂ defined by the starting slot (X₁) and the end slot (X₂), and using, by the UE, resources within the RSW₂ defined by X₁ and X₂ to identify resources for IUC information transmission.

Other aspects includes apparatuses, systems, and computer programs for performing the actions of the aforementioned method.

The innovative method can include other optional features. For example, in some implementations, the end slot (X₂) is based on S and the second UE's IUC information processing time (T_{proc,2}).

In some implementations, T_{proc,2} is the amount of time for the second UE to process MAC CE. In some implementations, T_{proc,2} is at least 3 ms.

In some implementations, T_{proc,2} is a predetermined number of physical slots. In some implementations, the number of physical slots is 3, 6, 12, or 24.

In some implementations, T_{proc,2} is based on sub-carrier spacing (SCS). In some implementations, the SCS is 0, 1, 2, or 3. In some implementations, the time T_{proc,2} becomes larger as the SCS increases. In some implementations, the time T_{proc,2} becomes smaller as the SCS decreases.

In some implementations, the starting slot of the RSW₁ for IUC information is (n+T₁).

In some implementations, T″₁ is >0 and T″1≤the UE's preparation time for PSCCH/PSSCH transmission (T_{proc,1}).

In some implementations, the starting slot of the RSW₁ is (n+T₁) and T″₁ is ≥0 and T″₁≤the UE's preparation time for PSCCH/PSSCH transmission (T_{proc,1}). In such implementations, the method can further include setting X₁ to (n+T₁)−T″₁.

In some implementations, X₂ is equal to S−T_{proc,2}.

In some implementations, method can further include determining whether S−T_{proc,2} is greater than a threshold number of slots (L), and based on a determination that S−T_{proc,2} is not greater than L, setting X₂ to X₁+L.

In some implementations, the method can further include determining whether S−T_{proc,2} is greater than a threshold number of slots (L), and based on a determination that S−T_{proc,2} is greater than L, setting X₂ to S−T_{proc,2}.

In some implementations, T_{proc,1} is the UE's preparation time for PSCCH/PSSCH transmission and X₂ is equal to S−T_{proc,1}−T_{proc,2}.

In some implementations, the method can further include transmitting, by the UE, an IUC information transmission that indicates resources for resource selection within the RSW₂ defined by X₁ and X₂.

According to another innovative aspect of the present disclosure, a method to be performed by user equipment (UE) for inter-UE coordination (IUC) is disclosed. In one aspect, the method can include generating, by the UE, IUC information with a plurality of resources sets, wherein the first resource of the plurality of resources is at slot S, determining, by the UE, whether there is a sidelink grant within a second resource selection window (RSW₂) having a starting slot (X₁) determined based on a first UE processing time (T″₁) and an end slot (X₃) determined based on S, based on a determination that there is not an available sidelink grant, triggering, by the UE, resource selection within RSW₂ defined by the starting slot (X₁) and the end slot (X₃), and using, by the UE, resources within the RSW₂ defined by X₁ and X₃ to identify resources for IUC information transmission.

Other aspects includes apparatuses, systems, and computer programs for performing the actions of the aforementioned method.

The innovative method can include other optional features. For example, in some implementations, the end slot (X₃) is based on S and the second UE's IUC information processing time (T_{proc,2}).

In some implementations, T_{proc,2} is the amount of time for the second UE to process MAC CE. In some implementations, T_{proc,2} is at least 3 ms.

In some implementations, T_{proc,2} is a predetermined number of physical slots. In some implementations, the number of physical slots is 3, 6, 12, or 24.

In some implementations, T_{proc,2} is based on sub-carrier spacing (SCS). In some implementations, the SCS is 0, 1, 2, or 3. In some implementations, the time T_{proc,2} becomes larger as the SCS increases. In some implementations, the time T_{proc,2} becomes smaller as the SCS decreases.

In some implementations, T″₁ is ≥0 and T″₁≤the UE's preparation time for PSCCH/PSSCH transmission (T_{proc,1}).

In some implementations, X₁ is determined based on T″₁ and (n+T₁). In some implementations, X₁ is equal to (n+T₁)−T″₁.

In some implementations, X₃ is equal to S−T_{proc,2}.

In some implementations the method can further include determining whether S−T_{proc,2} is greater than a threshold number of slots (L), and based on a determination that S−T_{proc,2} is not greater than L, setting X₃ to X₁+L.

In some implementations, the method can further include determining whether S−T_{proc,2} is greater than a threshold number of slots (L), and based on a determination that S−T_{proc,2} is greater than L, setting X₃ to S−T_{proc,2}.

In some implementations, T_{proc,1} is the UE's preparation time for PSCCH/PSSCH transmission and X₃ is equal to S−T_{proc,1}−T_{proc,2}.

In some implementations, the method can further include transmitting, by the UE, an IUC information transmission that indicates resources for resource selection within the RSW₂ defined by X₁ and X₃.

According to another innovative aspect of the present disclosure, a method to be performed by user equipment (UE) for inter-UE coordination (IUC) is disclosed. In one aspect, the method can include receiving, by the UE, an explicit request for IUC information transmission, determining, by the UE, a priority value for each of the preferred resources to be indicated by the IUC for information transmission, generating, by the UE, one or more IUC information transmission data structures that includes the determined priority values, and transmitting, by the UE, one or more IUC information transmission data structures to another UE.

Other aspects includes apparatuses, systems, and computer programs for performing the actions of the aforementioned method.

The innovative method can include other optional features. For example, in some implementations, at least one of the one or more IUC information transmission data structures is in SCI format 2-C.

In some implementations, at least one of the IUC information transmission data structures is in MAC CE format.

In some implementations, the one or more IUC information transmission data structures comprises a first data structure including IUC information and the determined priority values is in a MAC CE format, and the one or more IUC information transmission data structures also comprises a second data structure including IUC information and the determined priority values in an SCI format 2-C.

According to another innovative aspect of the present disclosure, a method to be performed by user equipment (UE) for inter-UE coordination (IUC) is disclosed. In one aspect, the method can include receiving, by the UE, a first IUC information transmission indicating a single preferred resource set from a second UE, receiving, by the UE, a second IUC information transmission indicating a single non-preferred resource set from the same second UE, and selecting, by the UE, resources indicated by the first IUC and the second IUC for subsequent transmission based on an identity of the UE that is to receive the subsequent transmission.

Other aspects includes apparatuses, systems, and computer programs for performing the actions of the aforementioned method.

The innovative method can further include other optional features. For example, in some implementations, the method further include determining, by the UE, that the identity of the UE that is to receive the subsequent transmission is the second UE, and based on a determination, by the UE, that the identity of the UE that is to receive the subsequent transmission is the second UE, selecting, by the UE, resources for the subsequent transmission from the single preferred resource set.

In some implementations, the method can further include determining, by the UE, that the identity of the UE that is to receive the subsequent transmission is a different UE than the second UE, and based on a determination, by the UE, that the identity of the UE that is to receive the subsequent transmission is a different UE than the second UE, selecting, by the

UE, resources for the subsequent transmission from excluding the single non-preferred resource set.

In some implementations, the method can further include determining, by the UE, that the identity of the UE that is to receive the subsequent transmission is a different UE than the second UE, and based on a determination, by the UE, that the identity of the UE that is to receive the subsequent transmission is a different UE than the second UE, determining, by the UE, to not select either the single preferred resource set or the single non-preferred resource set for the subsequent transmission.

In some implementations, the method can further include determining, by the UE, that the single preferred resource set and the single non-preferred resource set correspond to the same Tx resource, and based on a determination, by the UE, that the single preferred resource set and the single non-preferred set correspond to the same Tx resource, determining, by the UE, to select resources from the resources indicated by the first IUC or the second IUC that are the latest resources as valid resources.

According to another innovative aspect of the present disclosure, a method to be performed by user equipment (UE) for inter-UE coordination (IUC) is disclosed. In one aspect, the method can include receiving, by the UE, a first IUC information transmission indicating a single preferred resource set from a second UE, receiving, by the UE, a second IUC information transmission indicating a single non-preferred resource set from a third UE, where the second UE and the third UE are different UEs, and selecting, by the UE, resources indicated by the first IUC and the second IUC for subsequent transmission based on an identity of the UE that is to receive the subsequent transmission.

Other aspects includes apparatuses, systems, and computer programs for performing the actions of the aforementioned method.

The innovative method can include other optional features. For example, in some implementations, the method can further include determining, by the UE, that the identity of the UE that is to receive the subsequent transmission is the second UE, and based on a determination, by the UE, that the identity of the UE that is to receive the subsequent transmission is the second UE, selecting, by the UE, resources for the subsequent transmission from only the single preferred resource set.

In some implementations, the method can further include determining, by the UE, that the identity of the UE that is to receive the subsequent transmission is the third UE, and based on a determination, by the UE, that the identity of the UE that is to receive the subsequent transmission is the third UE, selecting, by the UE, resources for the subsequent transmission from excluding the single non-preferred resource set.

In some implementations, the method can further include determining, by the UE, that the identity of the UE that is to receive the subsequent transmission a different UE than the second UE and the third UE, and based on a determination, by the UE, that the identity of the UE that is to receive the subsequent transmission a different UE than the second UE and the third UE, selecting, by the UE, resources for the subsequent transmission from only the single non-preferred resource set.

In some implementations, the method can further include determining, by the UE, that the identity of the UE that is to receive the subsequent transmission a different UE than the second UE and the third UE, and based on a determination, by the UE, that the identity of the UE that is to receive the subsequent transmission a different UE than the second UE and the third UE, determining, by the UE, to not select either the single preferred resource set or the single non-preferred resource set for the subsequent transmission.

These and other innovative aspects of the present disclosure are described in more detail herein in the detailed description, the accompanying drawings, and the claims.

### BRIEF DESCRIPTION OF THE FIGURES

FIG. 1 illustrates an example communication system, according to some implementations.

FIG. 2 is a timing diagram of a resource selection process for IUC information transmission responsive to an explicit request.

FIG. 3 is a flowchart of an example of a process for identification of resources for IUC information transmission responsive to an explicit request.

FIG. 4 is a timing diagram of a resource selection process for IUC information transmission without an explicit request.

FIG. 5 is a flowchart of another example of a process for identification of resources for IUC information transmission without an explicit request.

FIG. 6 is a flowchart of an example of a process for indicating priority of resources in IUC information transmission.

FIG. 7 is a flowchart of a process for resource selection after receipt of multiple IUC information transmissions from the same UE.

FIG. 8 is a flowchart of a process for resource selection after receipt of IUC information transmission from different UE.

FIG. 9 illustrates a user equipment (UE), according to some implementations.

FIG. 10 illustrates an access node, according to some implementations.

Like reference symbols in the various drawings indicate like elements.

### DETAILED DESCRIPTION

The present disclosure describes methods, systems, apparatus, and computer programs for effective inter-UE coordination (IUC) scheme. Among other things, this disclosure describes methods for process for identification of resources for IUC information transmission, indicating priority of resources in IUC information transmission, resource selection after receipt of multiple IUC information transmissions from the same UE-A, and resource selection after receipt of multiple IUC information transmissions from different UE-As.

In the present specification, UE-B is a UE that is requesting/receiving resources via IUC whereas UE-A is a UE transmitting IUC. While, in some instances, a UE may be explicitly labeled as UE-B or UE-A, whether a particular UE described by the present disclosure is a UE-B or UE-A can be determined based on the operations performed by that particular UE (i.e., whether the UE is requesting/receiving resources via IUC or whether the UE is transmitting IUC).

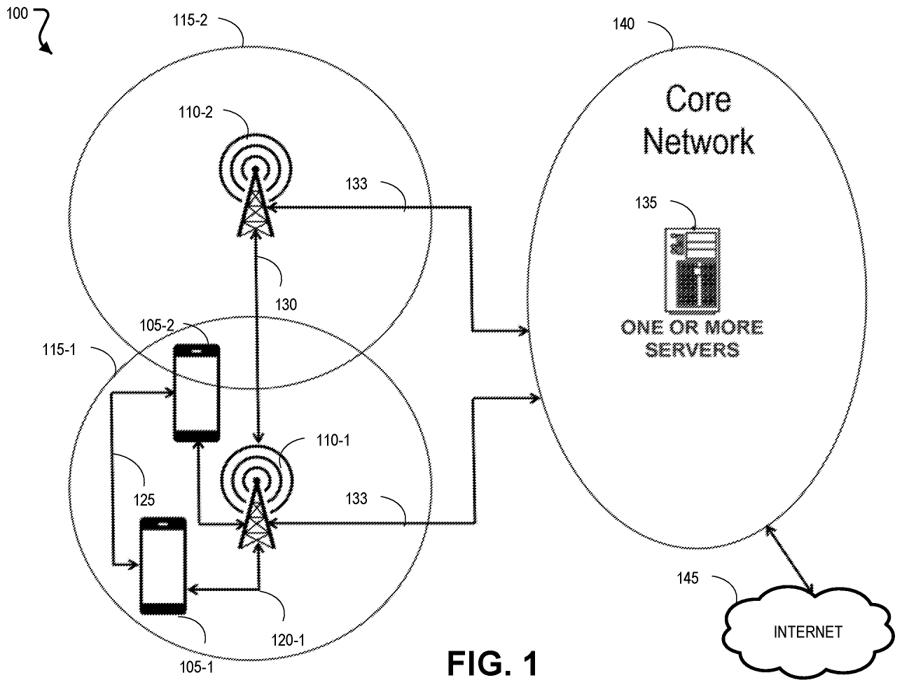

FIG. 1 illustrates an example communication system 100, according to some implementations. It is noted that the system of FIG. 1 is merely one example of a possible system, and that features of this disclosure may be implemented in other wireless communication systems.

The following description is provided for an example communication system 100 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi or Worldwide Interoperability for Microwave Access (WiMax) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 100 includes a number of user devices. As used herein, the term “user devices” may refer generally to devices that are associated with mobile actors or traffic participants in the communication system 100, e.g., mobile (able-to-move) communication devices such as vehicles and pedestrian user equipment (PUE) devices. More specifically, the V2X communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

As shown, certain user devices may be able to conduct communications with one another directly, i.e., without an intermediary infrastructure device such as base station 110-1. As shown, UE 105-1 may conduct communications (e.g., V2X-related communications) directly with UE 105-2. Similarly, the UE 105-2 may conduct communications directly with UE 105-2. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 105 may be physical hardware devices capable of running one or more applications, capable of accessing network services via one or more radio links 120 with a corresponding base station 110, and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs (not shown in FIG. 1) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1st SCI for the purpose of sensing and broadcast communication, and the 2nd SCI carrying the remaining information for data scheduling of unicast/groupcast data transmission.

In some implementations, the sidelink 125 is established through an initial beam pairing procedure. In this procedure, the UEs 105 identify (e.g., using a beam selection procedure) one or more potential beam pairs that could be used for the sidelink 125. A beam pair includes a transmitter beam from a transmitter UE (e.g., UE 105-1) to a receiver UE (e.g., UE 105-2) and a receiver beam from the receiver UE to the transmitter UE. In some examples, the UEs 105 rank the one or more potential beam pairs. Then, the UEs 105 select one of the one or more potential beam pairs for the sidelink 125, perhaps based on the ranking.

As stated, the air interface between two or more UEs 105 or between a UE 105 and a UE-type RSU (not shown in FIG. 1) may be referred to as a PC5 interface. To transmit/receive data to/from one or more eNBs 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105 may connect with base station 110-1 via link 120 and simultaneously connect with UE 105-2 via sidelink 125.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 105 are configured to perform sidelink beam failure recovery procedures. The V2X communication system 100 can enable or disable support of the sidelink beam failure recovery procedures in the UEs 105. More specifically, the V2X communication system 100 can enable or disable support per resource pool or per PC5-RRC configuration (which may depend on UE capability). In the sidelink beam failure recovery procedures, one of the UEs 105 is designated as a transmitter UE (e.g., UE 105-1) and the other UE is designated as a receiver UE (e.g., UE 105-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

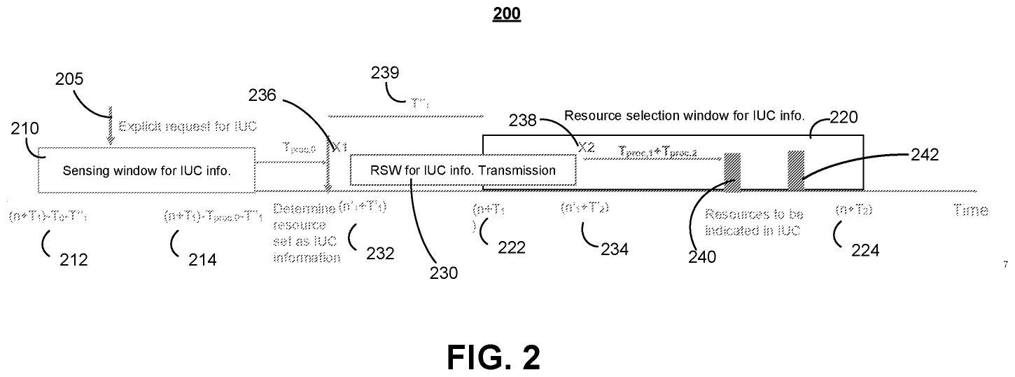

FIG. 2 is a timing diagram 200 of a resource selection process for IUC information transmission responsive to an explicit request 205. In this example, the timing diagram describes a sequence of events that begins with a UE-B (not shown) submitting an explicit request 205 for IUC information to a UE-A (not shown). The explicit request 205 is received by UE-A and indicates a starting slot (n+T₁) and an end slot (n+T₂) of a first resource selection window 220 for IUC information, with (n+T₁) and (n+T₂) each representing one value of a frame and slot index. However, if IUC information is triggered by a condition other than explicit request 205 reception, then the starting slot (n+T₁) and ending slot (n+T₂) of the resource selection window for ICU information are determined by UE-A's implementation.

Upon receipt of the explicit request 205, UE-A performs sensing operations using the sensing window 210 for IUC information. During this time, UE-A determines the availability of resources 240, 242 within the first resource selection window 220 for IUC information defined by the explicit request 205. This processing time period that elapses while UE-A senses, or otherwise determines, resource availability within the first resource selection window 220 for IUC information is referred to as T_{proc,0}.

Parameters may be established for defining a sensing window 210 for inter-UE coordination (IUC) information for IUC scheme 1. The sensing window 210 for determining the set of resources for IUC information can be derived based on the starting slot (n+T₁) 222 and ending slot (n+T₂) 224 of the resources selection window 220 for IUC information that is used for determining the set of resources in TS38.214 section 8.1.4. In particular, the sensing window is defined by the range of slots [(n+T₁)−T₀−T″₁, (n+T₁)−T_{proc,0}−T″₁] as shown in 212, 214, T_{proc,0} is the sensing results processing time. In such implementations, T″₁ refers to a processing time of UE-A and is up to UE-A's implementation. In some implementations, T″₁ falls within the bounds of 0≤T″₁≤T_{proc,1}, where T_{proc,1} is UE-A's preparation time for PSCCH/PSSCH transmission.

Once the availability of resources 240, 242 within the resource selection window 220 for IUC information is determined, UE-A can use a resource selection window 230 for IUC information transmission in order to identify resources that can be used by UE-A to transmit IUC information indicating available resources 240, 242 within the first resource selection window 220 to UE-B. In order to identify resources that can be used by UE-A to transmit IUC information to UE-B, UE-A must determine the boundaries 232, 234 of the second resource selection window 230 for IUC information transmission.

The parameter (n′+T′₁) 232 is defined as a start slot of resource selection window 230 used for sidelink transmission carrying inter-UE coordination information. The parameter (n′+T′₂) 234 is defined as the end slot of resource selection window 230 used for sidelink transmission carrying inter-UE coordination information. In such implementations, the parameter n′ is the slot where UE procedure of determining TX resources of sidelink transmission carrying inter-UE coordination information is triggered.

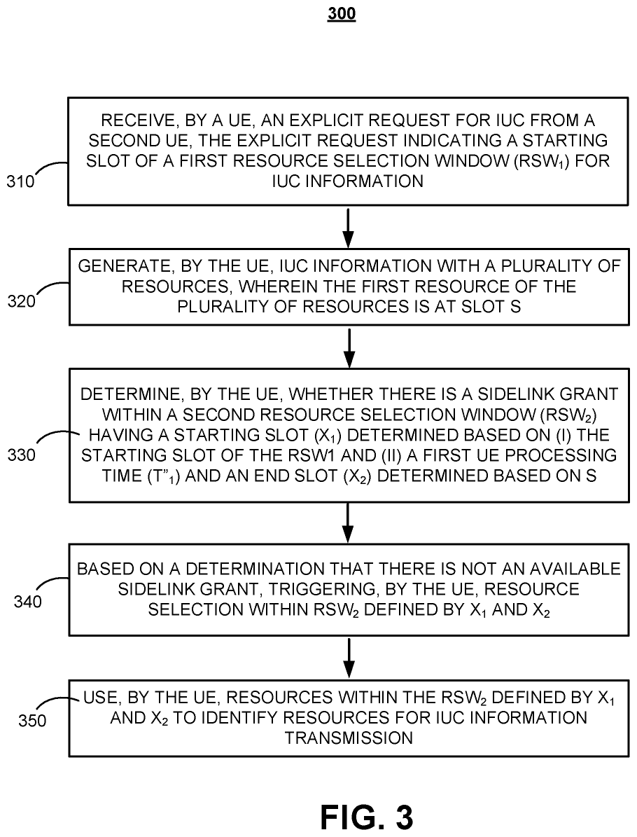

For inter-UE coordination information triggered by UE-B's explicit request, multiple implementations were proposed by RAN1 #108. In particular a resource selection window (RSW) 230 for IUC information transmission can be defined as starting at a time X₁ 236 and ending at either X₂ 238 for explicit request or X₃ (not shown in FIG. 2, but shown in FIG. 3, 338 and corresponds to X₂ for ICU triggered by condition other than explicit request). In a first implementation, X₁≤(n′+T′₁) and (n′+T′₂)≤X₂. Alternatively, for inter-UE coordination information triggered by a condition other than explicit request reception, (n′+T′₂)<X₃ (FIG. 3, 338).

The present disclosure provides for determinations of the boundaries for the resource selection window 230 for IUC information transmission.

### Resource Selection for Inter-UE Coordination (IUC) Information Transmission in Response to Explicit Request

For purposes of the present disclosure, T_{proc,0} is UE-A's sensing results processing time, T_{proc,1} is UE-A's preparation time for PSCCH/PSSCH transmission, and T_{proc,2} is UE-B's inter-UE coordination information processing time.

In some implementations, for example, T_{proc,2} can include the MAC CE processing time. In some implementations, for example, T_{proc,2} can be at least 3 ms for MAC CE processing time. Alternatively, or in addition, T_{proc,2} can be expressed in physical slots. Alternatively, or in addition, T_{proc,2} can depend on subcarrier spacing (SCS). In some implementations, T_{proc,2} may depend on UE-B capability. Accordingly, different UE-B capabilities can have two different values of T_{proc,2}.

For implementations, where T_{proc,2} is measured in SCS, the larger the SCS value, the larger the T_{proc,2} value. Likewise, in such implementations, the smaller the SCS value, the smaller the T_{proc,2} value. Exemplary values of T_{proc,2} in terms of SCS (μ_{L}) or physical slots are set forth below in Table 1:

TABLE 1

| SCS (u_{SL}) | T_{proc, 2} (slots) |
|---|---|
| 0 | 3 |
| 1 | 6 |
| 2 | 32 |
| 3 | 24 |

Value of a Start Slot (X₁) for a Resource Selection Window (RSW₂) for IUC Information Transmission:

In some implementations, the value of X₁ 236 is equal to (n+T₁)−T″₁. In such implementations, (n+T₁) is the start slot of RSW₁ 220 indicted in the explicit request and T″₁ 239 is up to UE-A's implementation under 0≤T″₁≤T_{proc,1}. Alternatively, if IUC is triggered by a condition other than explicit request reception, this value of (n+T₁) 222 is determined by UE-A's implementation.

Value of an End Slot (X₂) for a Resource Selection Window (RSW₂) for IUC Information Transmission:

S is a reference slot location indicated in IUC information transmission. In some implementations, the reference slot S can be the slot of the first indicated resources in IUC. In the example of FIG. 2, S is the slot of resource 240.

The value of X₂ 238 is based on the value of S, T_{proc,2}, or both. For example, in some implementations, the value of X₂ is equal to S−T_{proc,2}. In other implementations, the value of X₂ is equal to S−T_{proc,1}−T_{proc,2}. In such implementations, T_{proc,1} is UE-A's preparation time for PSCCH/PSSCH transmission.

However, in some implementations, the value of X₂ can be required to be large enough to satisfy a predetermined minimum resource selection window L in order to allow sufficient candidates for selecting a resource. For example, in some implementations, L can be set to 20 slots. In general, implementations requiring a predetermined minimum resource selection window L can require that X₂ must satisfy can be express as, e.g., X₂=max (X₁+L, S−T_{proc,2}). In such implementations, X₁ 236 is the start slot for RSW₂ 220. In some implementations, even if S is outdated in this case, S+P_{rsvp_tx} can still be a valid preferred or non-preferred resource.

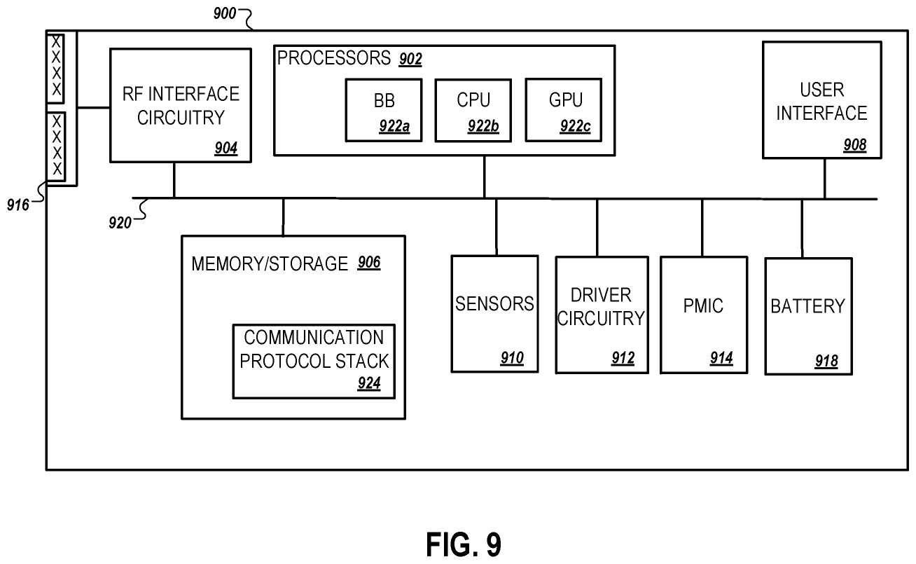

FIG. 3 is a flowchart of an example of a process 300 for identification of resources for IUC information transmission responsive to an explicit request. The process 300 is described as being performed by a UE-A. A UE-A can have features of a UE such as, e.g., UE 900 described with reference to FIG. 9 below.

A UE-A can begin execution of the process 300 by receiving an explicit request for IUC from a second UE, the explicit request indicating a starting slot of a first resource selection window (RSW₁) for IUC information (310).

The UE-A can continue execution of the process 300 by generating IUC information with a plurality of resources sets (320). In such implementations, the first resource of the plurality of resources is at slot S.

The UE-A can continue execution of the process 300 by determining whether there is a sidelink grant within a second resource selection window (RSW₂) having a starting slot (X₁) determined based on (i) the starting slot of the (RSW₁) and (ii) a first UE processing time (T″₁) and an end slot (X₂) determined based on S (330). In some implementations, the starting slot of the RSW₁ for IUC information is (n+T₁). In some implementations, T″₁ is ≥0 and T″₁≤the UE's preparation time for PSCCH/PSSCH transmission (T_{proc,1}). In some implementations, UE-A can set X₁ equal to (n+T₁)−T″₁. In some implementations, the end slot (X₂) is based on S and the second UE's (i.e., UE-B's) IUC information processing time (T_{proc,2}).

In some implementations, T_{proc,2} is the amount of time for the second UE to process MAC CE. In some implementations, T_{proc,2} is at least 3 ms. In some implementations, T_{proc,2} is a predetermined number of physical slots. In some implementations, the number of physical slots is 3, 6, 12, or 24. In some implementations, T_{proc,2} is based on sub-carrier spacing (SCS). In some implementations, the SCS is 0, 1, 2, or 3. In some implementations, as the time T_{proc,2} becomes larger as the SCS increases. In some implementations, as the time T_{proc,2} becomes smaller as the SCS decreases. In some implementations, X₂ equal to S−T_{proc,2}. In some implementations, X₂ is equal to S−T_{proc,1}−T_{proc,2}, where wherein T_{proc,1} is the UE-A's preparation time for PSCCH/PSSCH transmission.

Based on a determination that there is not an available sidelink grant, the UE-A can continue execution of the process 300 by triggering resource selection within RSW₂ defined by the starting slot (X₁) and the end slot (X₂) (340). The UE-A can continue execution of the process 300 by using resources within the RSW₂ defined by X₁ and X₂ to identify resources for IUC information transmission (350).

In some implementations, execution of the process 300 can include UE-A determining whether S−T_{proc,2} is greater than a threshold number of slots (L). Based on a determination by UE-A that S−T_{proc,2} is not greater than L, execution of the process 300 can include UE-A setting X₂ to X₁+L.

In some implementations, execution of the process 300 can include UE-A determining whether S−T_{proc,2} is greater than a threshold number of slots (L). In such implementations, based on a determination by UE-A that S−T_{proc,2} is greater than L, execution of the process 300 can include UE-A setting X₂ to S−T_{proc,2}.

In some implementations, execution of the process 300 can include UE-A transmitting an IUC information transmission that indicates resources for resource selection within the RSW₂ defined by X₁ and X₂.

The aforementioned process can be concisely described in a series of successive, exemplary steps. The first step can include UE-A receiving explicit request for IUC transmission. The second step can include the UE-A generating IUC information with resource sets, wherein S is the first resource indicated in IUC information. The third step can include UE-A checking if there is a sidelink grant available for IUC information transmission, wherein the sidelink grant has to be within the window of [n+T₁-T″₁, X₂] or [X₁,X₂], wherein X₂ is based on S in the resource set. In some implementations, X₂ is the actual PDB for the IUC information transmission. The fourth step can include determining if no existing available sidelink grant, then UE-A triggers resource selection with resource selection window of [X₁,X₂]. The fifth step can include the UE-A selecting a resource within slot [X₁, X₂] and creates a sidelink grant for IUC information transmission.

Resource Selection for Inter-UE Coordination (IUC) Information Transmission without Explicit Request

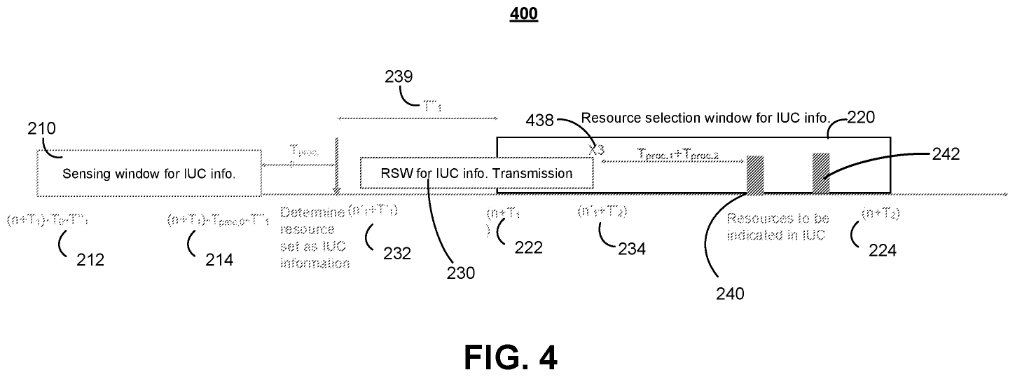

FIG. 4 is a timing diagram 400 of a resource selection process for IUC information transmission without an explicit request. FIG. 4 is generally the same as FIG. 2, but without the resource selection processing being triggered by explicit request. In such implementations, the end of the RSW 230 for IUC information transmission in FIG. 4 is denoted as X₃ 438, whereas the end of the RSW for IUC information transmission is denoted as X₂ 238 in FIG. 2.

In the timing diagram 400, the values of (n+T1) and (n+T2) are determined by UE-A's implementation since there is no explicit request.

Value of a Start Slot (X₁) for a Resource Selection Window (RSW₂) for IUC Information Transmission without Explicit Request:

If IUC is triggered by a condition other than explicit request reception, this value of (n+T₁) 222 is determined by UE-A's implementation.

Value of an End Slot (X₃) for a Resource Selection Window (RSW₂) for IUC Information Transmission without Explicit Request:

S is a reference slot location indicated in IUC information transmission. In some implementations, the reference slot S can be the slot of the first indicated resources in IUC. In the example of FIG. 4, S is the slot of resource 240.

The value of X₃ 438 is based on the value of S, T_{proc,2}, or both. For example, in some implementations, the value of X₃ is equal to S−T_{proc,2}. In other implementations, the value of X₃ is equal to S−T_{proc,1}−T_{proc,2}. In such implementations, T_{proc,1} is UE-A's preparation time for PSCCH/PSSCH transmission.

However, in some implementations, the value of X₃ can be required to be large enough to satisfy a predetermined minimum resource selection window L in order to allow sufficient candidates for selecting a resource. For example, in some implementations, L can be set to 20 slots. In general, implementations requiring a predetermined minimum resource selection window L can require that X₂ must satisfy can be express as, e.g., X₃=max (X₁+L, S−T_{proc,2}). In such implementations, X₁ 236 is the start slot for RSW₂ 220. In some implementations, even if S is outdated in this case, S+P_{rsvp_tx} can still be a valid preferred or non-preferred resource.

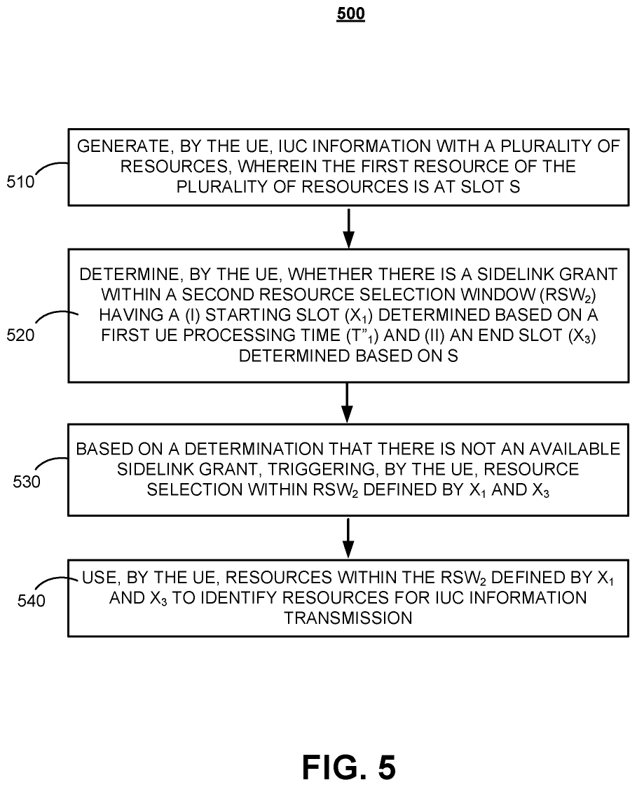

FIG. 5 is a flowchart of another example of a process for identification of resources for IUC information transmission without an explicit request. The process 500 is described as being performed by a UE-A. A UE-A can have features of a UE such as, e.g., UE 900 described with reference to FIG. 9 below.

UE-A can begin execution of the process 500 by generate IUC information with a plurality of resources sets (510). In such implementations, the first resource of the plurality of resources is at slot S.

The UE-A can continue execution of the process 500 by determining whether there is a sidelink grant within a second resource selection window (RSW₂) having a starting slot (X₁) determined based on a first UE processing time (T″₁) and an end slot (X₃) determined based on S (520). In some implementations, the UE-A can determine X₁ based on (n+T₁) and T″₁, with (n+T₁) being determined based on UE-A's implementation in the absence of an explicit request. In some implementations, UE-A can set the starting slot X₁ equal to (n+T₁)−T″₁, with (n+T₁) being determined based on UE-A's implementation in the absence of an explicit request. In some implementations, T″₁ is >0 and T″₁≤the UE-A's preparation time for PSCCH/PSSCH transmission (T_{proc,1}). In some implementations, the end slot (X₃) is based on S and the second UE (i.e., UE-B's) IUC information processing time (T_{proc,2}).

In some implementations, T_{proc,2} is the amount of time for the second UE to process MAC CE. In some implementations, T_{proc,2} is at least 3 ms. In some implementations, T_{proc,2} is a predetermined number of physical slots. In some implementations, the number of physical slots is 3, 6, 12, or 24. In some implementations, T_{proc,2} is based on sub-carrier spacing (SCS). In some implementations, the SCS is 0, 1, 2, or 3. In some implementations, as the time T_{proc,2} becomes larger as the SCS increases. In some implementations, the time T_{proc,2} becomes smaller as the SCS decreases. In some implementations, UE-A sets X₃ equal to S−T_{proc,2}. In some implementations, UE-A can set X₃ is equal to S−T_{proc,1}−T_{proc,2}, where T_{proc,1} is the UE-A's preparation time for PSCCH/PSSCH transmission.

Based on a determination that there is not an available sidelink grant, UE-A can continue execution of the process 500 by triggering resource selection within RSW₂ defined by the starting slot (X₁) and the end slot (X₃) (530). The UE-A can continue execution of the process 500 by using resources within the RSW₂ defined by X₁ and X₃ to identify resources for IUC information transmission (540).

In some implementations, execution of the process 500 can include UE-A determining whether S−T_{proc,2} is greater than a threshold number of slots (L). In such implementations, based on a determination by UE-A that S−T_{proc,2} is not greater than L, execution of the process 500 can include UE-A setting X₃ to X₁+L.

In some implementations, execution of the process 500 can include UE-A determining whether S−T_{proc,2} is greater than a threshold number of slots (L). In such implementations, based on a determination by UE-A that S−T_{proc,2} is greater than L, execution of the process 500 can include UE-A setting X₃ to S−T_{proc,2}.

In some implementations, execution of process 500 can include UE-A transmitting an IUC information transmission that indicates resources for resource selection within the RSW₂ defined by X₁ and X₃.

### Priority Indication in Inter-UE Coordination (IUC) Information

Problems with Existing Methods

Based on the existing methods, the inter-UE coordination information, either in SCI format 2-C or MAC CE, does not carry priority value used by UE-A to determine the preferred resource set. In such implementations, there are three different ways for UE-A to determine the priority value to be used in determining the preferred resource set. In some implementations, the priority value for a preferred resource set can be determined based on explicit request from UE-B. In other implementations, the priority value for a preferred resource set can be determined based on the resource pool (pre) configuration. In other implementations, the priority value for a preferred resource set can be determined based on UE-A implementation.

However, in such implementations, a UE-A can send multiple inter-UE coordination to UE-B. In such instances, UE-B does not know which priority value is used by UE-A in determining the corresponding preferred resource set when both explicit request triggered and condition triggered inter-UE coordination information are supported.

### Indication of Priority in IUC

To solve the aforementioned problems, the present disclosure provides a container of priority value associated with IUC information. In some implementations, only MAC CE includes priority value associated with the preferred resources. In some implementations, a single priority is indicated in the MAC CE. In some implementations, both MAC CE and SCI Format 2-C include priority value associated with the preferred resources.

In some implementations, a priority value field can be omitted by UE-B for a set of non-preferred resources. In such implementations, the priority value only applies for a set of preferred resources

Accordingly, the priority value of transmit data is not used when UE-A determines a set of non-preferred resources. Instead, the priority value of transmit data is used when UE-A determines a set of preferred resources.

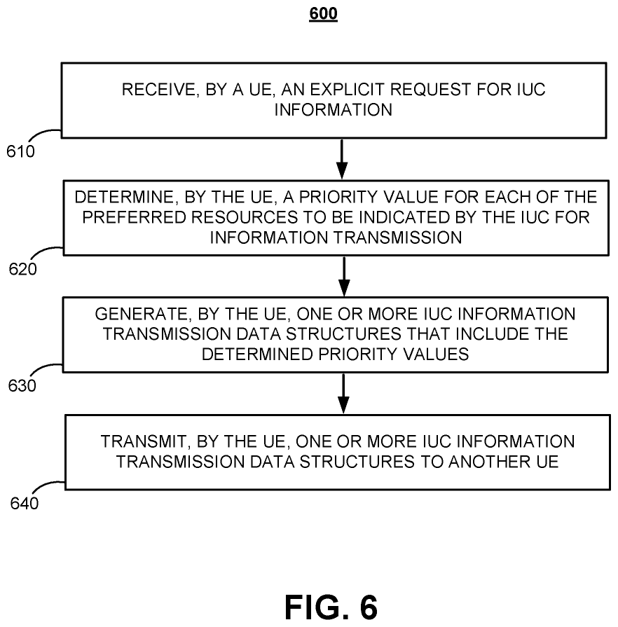

FIG. 6 is a flowchart of an example of a process 600 for indicating priority of resources in IUC information transmission. The process 600 is described as being performed by a UE-A. A UE-A can have features of a UE such as, e.g., UE 900 described with reference to FIG. 9 below.

UE-A can begin execution of the process 600 by receiving an explicit request for IUC information transmission (610). The UE-A can continue execution of the process 600 by determining a priority value for each of the preferred resources to be indicated by the IUC for information transmission (620). The UE-A can continue execution of the process 600 by generating one or more IUC information transmission data structures that includes the determined priority values (630). The UE can continue execution of the process 600 by transmitting, by the UE, one or more IUC information transmission data structures to another UE (640).

In some implementations, at least one of the one or more IUC information transmission data structures is in SCI format 2-C. In some implementations, at least one of the IUC information transmission data structures is in MAC CE format.

In some implementations, the one or more IUC information transmission data structures comprises a first data structure including IUC information and the determined priority values is in a MAC CE format. And, in the same implementation, the one or more IUC information transmission data structures also comprises a second data structure including IUC information and the determined priority values in an SCI format 2-C.

UE-B's Behavior after Receiving Preferred Resource Set and Non-Preferred Resource Set

Case 1: IUC is from the same UE-A

In some implementations, UE-B receives both a single preferred resource set and a single non-preferred resource set from the same UE vis IUC from the same UE-A. In such instances, for transmission to UE-A, the single preferred resource set is used in UE-B's resource (re) selection. Alternatively, in a first implementation for transmission to other UEs, only the single non-preferred resource set is used in UE-B's resource (re) selection. In a second implementation for transmission to other UEs, neither of the resource set is used in UE-B's resource (re) selection.

In a specific implementation both preferred resources and non-preferred resources correspond to the same Tx resource. In such implementations, UE-B can take the latest information as valid and invalidate the older one.

In some implementations, preferred resources may include whitelisted resources and non-preferred resources may include blacklisted resources. In other implementations, preferred resources may be resources that have a higher rating than non-preferred resources.

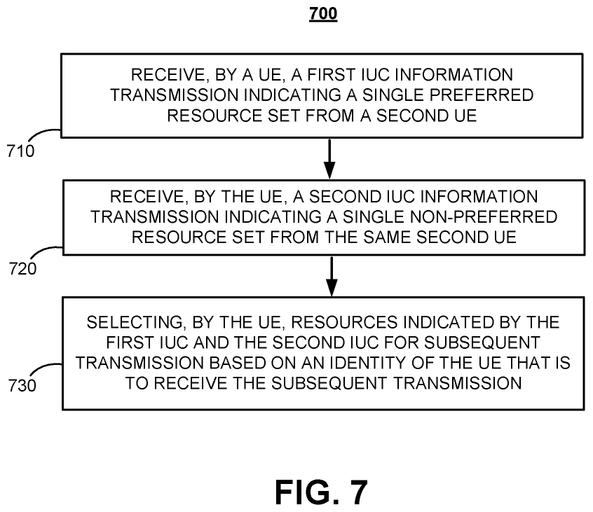

FIG. 7 is a flowchart of a process for resource selection after receipt of multiple IUC information transmissions from the same UE. The process 700 is described as being performed by a UE-B. A UE-B can have features of a UE such as, e.g., UE 900 described with reference to FIG. 9 below.

UE-B can begin execution of the process 700 by receiving a first IUC information transmission indicating a single preferred resource set from a second UE (710). The UE-B can continue execution of the process 700 by receiving a second IUC information transmission indicating a single non-preferred resource set from the same second UE (i.e., same UE-A) (720). The UE-B can continue execution of the process 700 by selecting resources indicated by the first IUC and the second IUC for subsequent transmission based on an identity of the UE that is to receive the subsequent transmission (730).

In some implementations, execution of the process 700 can include UE-B determining that the identity of the UE that is to receive the subsequent transmission is the second UE. In such implementations, based on a determination by UE-B that the identity of the UE that is to receive the subsequent transmission is the second UE, execution of the process 700 can include UE-B selecting resources for the subsequent transmission from the single preferred resource set.

In some implementations, execution of the process 700 can include UE-B determining that the identity of the UE that is to receive the subsequent transmission is a different UE than the second UE. In such implementations, based on a determination by UE-B that the identity of the UE that is to receive the subsequent transmission is a different UE than the second UE, execution of the process 700 can include UE-B selecting resources for the subsequent transmission from excluding the single non-preferred resource set. Alternatively, in other implementations, based on a determination by UE-B that the identity of the UE that is to receive the subsequent transmission is a different UE than the second UE, execution of the process 700 can include UE-B determining to not select either the single preferred resource set or the single non-preferred resource set for the subsequent transmission.

In some implementations, execution of the process 700 can include UE-B determining that the single preferred resource set and the single non-preferred resource set correspond to the same Tx resource. In such implementations, based on a determination by UE-B that the single preferred resource set and the single non-preferred set correspond to the same Tx resource, execution of the process 700 can include UE-B determining to select resources from the resources indicated by the first IUC or the second IUC that are the latest resources as valid resources.

Case 2: IUC is from Different UE-a(s)

In some implementations, UE-B receives both a single preferred resource set and a single non-preferred resource set from different UE-A(s). In such instances, for transmission to a UE-A indicating a single resource set, the corresponding resource set is used in UE-B's resource (re) selection. Alternatively, in a first implementation for transmission to a UE not providing a single resource set, only the set of non-preferred resource set is used in UE-B's resource (re) selection. Alternatively, in a second implementation for transmission to a UE not providing a single resource set, neither of the resource ret is used in UE-B's resource (re) selection.

In general, for Case 1 and Case 2, the overall logic is that preferred resource set already takes UE-A's sensing results and half-duplex constraints into account. And, non-preferred resource set serves as assistant information for UE-B's data transmissions to other UEs.

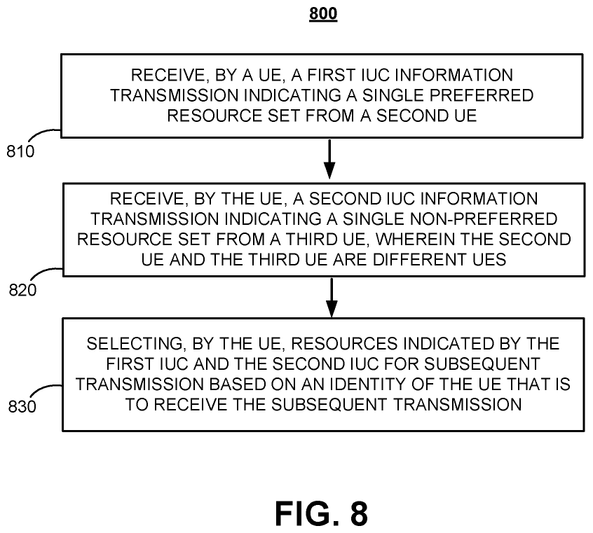

FIG. 8 is a flowchart of a process for resource selection after receipt of IUC information transmission from different UE. The process 800 is described as being performed by a UE-B. A UE-B can have features of a UE such as, e.g., UE 900 described with reference to FIG. 9 below.

UE-B can begin execution of the process 800 by receiving a first IUC information transmission indicating a single preferred resource set from a second UE (810). UE-B can continue execution of the process 800 by receiving a second IUC information transmission indicating a single non-preferred resource set from a third UE, where the second UE and the third UE are different UEs (i.e., different UE-As) (820). UE-B can continue execution of the process 800 by selecting resources indicated by the first IUC and the second IUC for subsequent transmission based on an identity of the UE that is to receive the subsequent transmission.

In some implementations, execution of the process 800 can include UE-B determining that the identity of the UE that is to receive the subsequent transmission is the second UE. In such implementations, based on a determination by UE-B that the identity of the UE that is to receive the subsequent transmission is the second UE, execution of the process 800 can include UE-B selecting resources for the subsequent transmission from only the single preferred resource set.

In some implementations, execution of the process 800 can include UE-B determining that the identity of the UE that is to receive the subsequent transmission is the third UE. In such implementations, based on a determination by UE-B that the identity of the UE that is to receive the subsequent transmission is the third UE, execution of the process 800 can include UE-B selecting resources for the subsequent transmission from only the single non-preferred resource set.

In some implementations, execution of the process 800 can include determining that the identity of the UE that is to receive the subsequent transmission a different UE than the second UE and the third UE. In such implementations, based on a determination by UE-B that the identity of the UE that is to receive the subsequent transmission a different UE than the second UE and the third UE, execution of the process 800 can include UE-B selecting resources for the subsequent transmission from only the single non-preferred resource set.

In some implementations, execution of the process 800 can include UE-B determining that the identity of the UE that is to receive the subsequent transmission a different UE than the second UE and the third UE. In such implementations, based on a determination by UE-B that the identity of the UE that is to receive the subsequent transmission a different UE than the second UE and the third UE, execution of the process 800 can include UE-B determining to not select either the single preferred resource set or the single non-preferred resource set for the subsequent transmission.

FIG. 9 illustrates a UE 900, in accordance with some implementations. The UE 900 may be similar to and substantially interchangeable with UEs 105 of FIG. 1.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, antenna structure 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 916.

In various implementations, the RF interface circuitry 904 may be configured to transmit/receive signals in a manner compatible with NR access technologies.

The antenna 916 may include antenna elements to convert electrical signals into radio waves to travel through the air and to convert received radio waves into electrical signals. The antenna elements may be arranged into one or more antenna panels. The antenna 916 may have antenna panels that are omnidirectional, directional, or a combination thereof to enable beamforming and multiple input, multiple output communications. The antenna 916 may include microstrip antennas, printed antennas fabricated on the surface of one or more printed circuit boards, patch antennas, phased array antennas, etc. The antenna 916 may have one or more panels designed for specific frequency bands including bands in FRI or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensor circuitry 928 and control and allow access to sensor circuitry 928, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900 including DRX as discussed herein. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

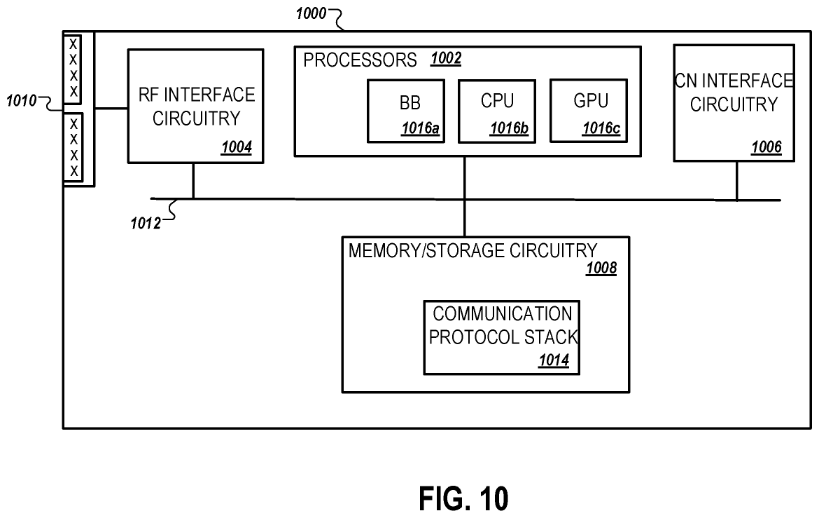

FIG. 10 illustrates an access node 1000 (e.g., a base station or gNB), in accordance with some implementations. The access node 1000 may be similar to and substantially interchangeable with base stations 110. The access node 1000 may include processors 1002, RF interface circuitry 1004, core network (CN) interface circuitry 1006, memory/storage circuitry 1008, and antenna structure 1010.

The components of the access node 1000 may be coupled with various other components over one or more interconnects 1012. The processors 1002, RF interface circuitry 1004, memory/storage circuitry 1008 (including communication protocol stack 1014), antenna structure 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-60. (canceled)

61. One or more processors configured to perform operations comprising:
receiving an indication of a sidelink inter-user equipment (UE) coordination (IUC) scheme;
receiving, in accordance with the sidelink IUC scheme, sidelink control information (SCI) that indicates a request for IUC information;
selecting one or more candidate sidelink resources from a non-preferred resource set based at least on a first sidelink processing time (T_{proc,0}), a second sidelink processing time (T_{proc,1}), and a third sidelink processing time (T_{proc,2}); and
instructing radio frequency (RF) circuitry to transmit the requested IUC information via the one or more selected candidate sidelink resources.

62. The one or more processors of claim 61, wherein the third sidelink processing time (T_{proc,2}) is equal to a summation of the first sidelink processing time (T_{proc,0}) and the second sidelink processing time (T_{proc,1}).

63. The one or more processors of claim 61, wherein the third sidelink processing time (T_{proc,2}) is equal to the first sidelink processing time (T_{proc,0}).

64. The one or more processors of claim 61, wherein selecting the one or more candidate sidelink resources comprises:
determining a set of candidate single-slot resources available for transmission of the IUC information; and
excluding, from the set of candidate single-slot resources, one or more resources that overlap with the non-preferred resource set.

65. The one or more processors of claim 61, wherein the sidelink IUC scheme indicates that transmission of IUC information is triggered by an explicit request.

66. The one or more processors of claim 61, wherein the sidelink IUC scheme indicates a priority value for sensing and candidate resource selection for transmission of a transport block (TB) containing the IUC information.

67. The one or more processors of claim 61, wherein the sidelink IUC scheme indicates whether SCI format 2-C can be used to convey the IUC information.

68. The one or more processors of claim 61, wherein transmitting the requested IUC information comprises transmitting a medium access control (MAC) control element (MAC-CE) comprising the requested IUC information.

69. The one or more processors of claim 61, wherein transmitting the requested IUC information comprises transmitting the requested IUC information using SCI format 2-C.

70. The one or more processors of claim 61, wherein the request further indicates at least one of a priority, a number of subchannels, a resource reservation period, a resource selection window location, or a resource set type to use for transmission of the IUC information.

71. The one or more processors of claim 61, wherein the request for IUC information is received using SCI format 2-C.

72. The one or more processors of claim 61, wherein selecting the one or more candidate sidelink resources comprises determining a resource set type to use for transmission of the requested IUC information based at least in part on a sidelink resource type determination field of the sidelink IUC scheme.

73. The one or more processors of claim 61, wherein selecting the one or more candidate sidelink resources comprises:
determining a sensing window based at least on the first sidelink processing time (T_{proc,0}) and a number of slots (To) associated with a sidelink resource pool configuration; and
performing full or partial sensing of the one or more candidate sidelink resources within the sensing window in accordance with the sidelink IUC scheme.

74. The one or more processors of claim 61, wherein the first sidelink processing time (T_{proc,0}) comprises a first quantity of slots associated with a user equipment (UE) processing capability.

75. The one or more processors of claim 74, wherein the first quantity of slots is based at least in part on a subcarrier spacing (SCS) configuration of a sidelink bandwidth part (BWP) comprising the one or more candidate sidelink resources.

76. The one or more processors of claim 61, wherein the second sidelink processing time (T_{proc,1}) comprises a second quantity of slots associated with a user equipment (UE) processing capability.

77. The one or more processors of claim 76, wherein the second quantity of slots is based at least in part on a subcarrier spacing (SCS) configuration of a sidelink bandwidth part (BWP) comprising the one or more candidate sidelink resources.

78. A method comprising:
receiving an indication of a sidelink inter-user equipment (UE) coordination (IUC) scheme;
receiving, in accordance with the sidelink IUC scheme, sidelink control information (SCI) that indicates a request for IUC information;
selecting one or more candidate sidelink resources from a non-preferred resource set based at least on a first sidelink processing time (T_{proc,0}), a second sidelink processing time (T_{proc,1}), and a third sidelink processing time (T_{proc,2}); and
outputting the requested IUC information for transmission via the one or more selected candidate sidelink resources.

79. The method of claim 78, wherein the third sidelink processing time (T_{proc,2}) is equal to a summation of the first sidelink processing time (T_{proc,0}) and the second sidelink processing time (T_{proc,1}).

80. A user equipment (UE) comprising:
one or more processors; and
memory storing instructions that, when executed by the one or more processors, cause the UE to perform operations comprising:
receiving an indication of a sidelink inter-UE coordination (IUC) scheme;
receiving, in accordance with the sidelink IUC scheme, sidelink control information (SCI) that indicates a request for IUC information;
selecting one or more candidate sidelink resources from a non-preferred resource set based at least on a first sidelink processing time (T_{proc,0}), a second sidelink processing time (T_{proc,1}), and a third sidelink processing time (T_{proc,2}); and
transmitting the requested IUC information via the one or more selected candidate sidelink resources.
